(19) United States
(12) Patent Application Publication
(10) Pub. No.: US 2010/0095982 A1
(43) Pub. Date: Apr. 22, 2010

(54) FILM CLEANING SYSTEM

(76) Inventors: Steven Garlick, Chino Hills, CA (US); David Gilmartin, Chino Hills, CA (US); Dennis Kenneth Jones, Montrose, CA (US)

Correspondence Address: Robert D. Shedd, Patent Operations;THOMSON Licensing LLC, P.O. Box 5312, Princeton, NJ, 08543-5312, US

(21) Appl. No.: 12/451,830

(22) PCT Filed: Jun. 4, 2007
(86) PCT No.: PCT/US07/13155

§ 371 Date: Dec. 2, 2009

(51) Int. Cl. G03D 3/13; B08B 7/00

(52) U.S. Cl. 134/6; 134/122 R

(57) ABSTRACT

A film cleaning system for removing debris from film is described. The film cleaning system includes at least one cleaning member. Associated with each cleaning member is an adhesive member. As the film begins its transport through the cleaning system and is brought into contact with the cleaning member the adhesive member is engaged with the cleaning member. The cleaning member removes debris from the film and the adhesive member prevents the cleaning member from being loaded with debris from the film providing a self-cleaning attribute as well as improving the quality and cleanliness of the film.

### BACKGROUND OF THE INVENTION

1. Field of the Invention

The present invention relates to film development apparatus and, more particularly to a film cleaning system therefor.

2. Description of the Background Art

Images captured in printed pictures or on film are used to communicate information and ideas. Color film based images are typically produced by irradiating a silver halide-based emulsion thereon to produce a latent image in the silver halide grains of the emulsion, The exposed color film may then be conventionally developed using a chemical developing process.

Film developed using conventional chemical developing processes may contain loose debris on the cell and emulsion sides thereof. Such debris undesirably affects the quality of subsequent film processing, e.g., printing or further development.

Particle transfer rollers (PTRs) have been used to remove the debris from the film. The film is brought in contact with a particle transfer roller that is mounted on a rotating disk. The loose debris is transferred onto the particle transfer roller. However, hours per day of maintenance is required to clean the PTR to prevent debris from a dirtied PTR from being transferred onto subsequently processed film.

Brush boxes have also been used to remove the loose debris from the film. The brushes of the brush box are brought in close proximity to the film such that debris protruding away from the surface of the film is removed. Unfortunately, positioning the brushes in such close proximity to the film increases the risk of film scratches damaging the film.

Thus, a film cleaning system for removing debris from film is desired.

### SUMMARY OF THE INVENTION

The present invention relates to a film cleaning system for removing debris from film. The film cleaning system includes at least one cleaning member. Associated with each cleaning member is an adhesive member. As the film begins its transport through the cleaning system and is brought into contact with the cleaning member the adhesive member is engaged with the cleaning member. The cleaning member removes debris from the film and the adhesive member prevents the cleaning member from being loaded with debris from the film providing a self-cleaning attribute as well as improving the quality and cleanliness of the film.

### BRIEF DESCRIPTION OF THE DRAWINGS

The invention will now be described in greater detail, with relation to the accompanying drawings, in which

FIG. 1 is a front view of the film cleaning system of the present invention;

FIG. 2 is an exploded view of the film cleaning apparatus shown in FIG. 1;

and

FIG. 3 is a rear view of the film cleaning apparatus shown in FIG. 1.

### DETAILED DESCRIPTION

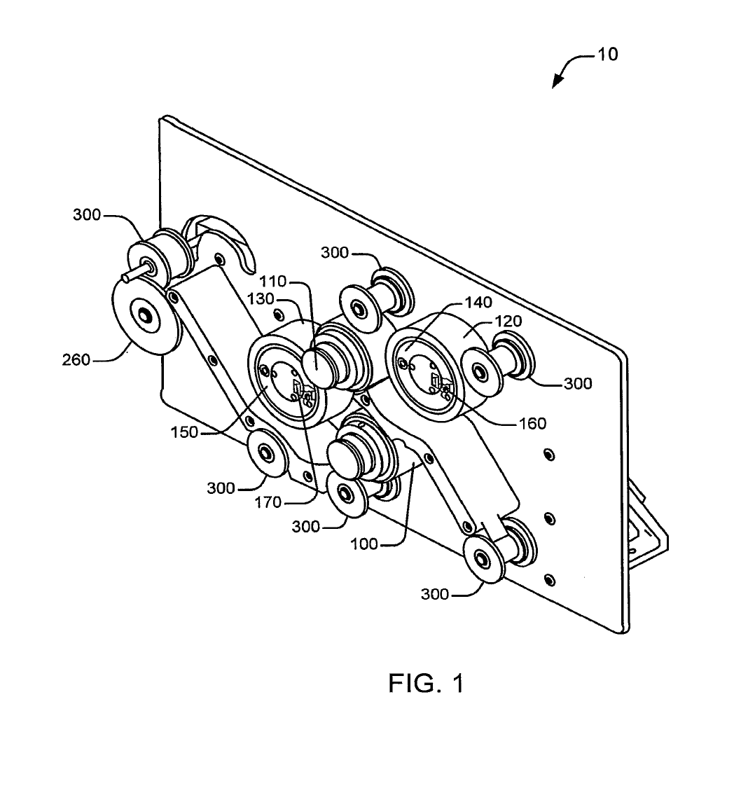

The present invention relates to a film cleaning system for removing debris from film. Referring to FIGS. 1-3, the film cleaning system is a modular unit that may be installed on film industry equipment, such as, for example, printers and developers. The film cleaning system may optionally be configured into a stand alone film cleaning station.

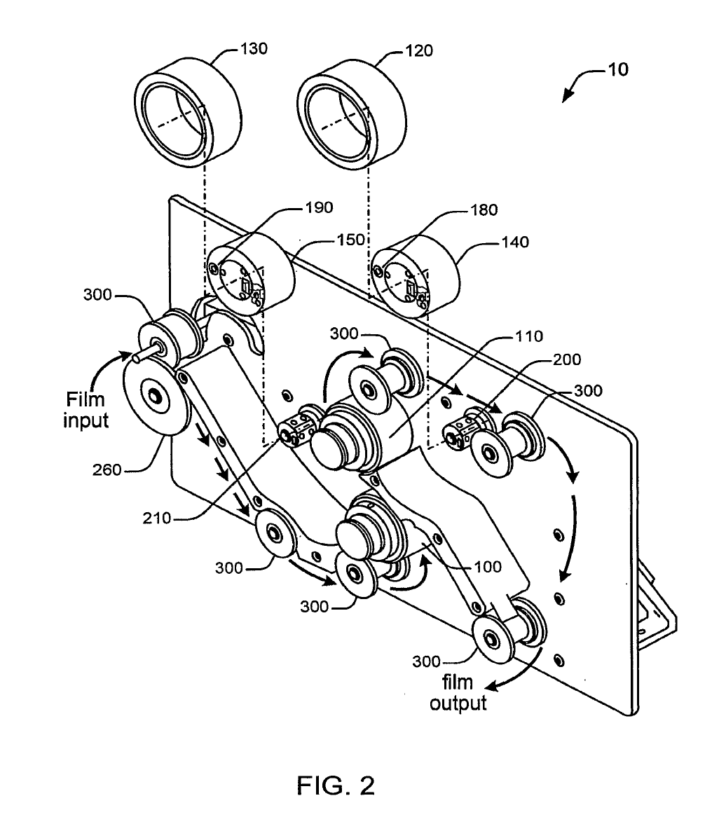

The film cleaning system removes debris from the cell and emulsion sides of a film element. The film cleaning is performed before or after a printing operation or a developing operation. Referring to FIGS. 1-2, the film cleaning system 10 includes at least one cleaning member 100, 110. Associated with each cleaning member 100, 110 is an adhesive member 120, 130. Each adhesive member 120, 130 is mounted on a corresponding hub assembly 140, 150 with a tapered screw 180, 190 (FIG. 2).

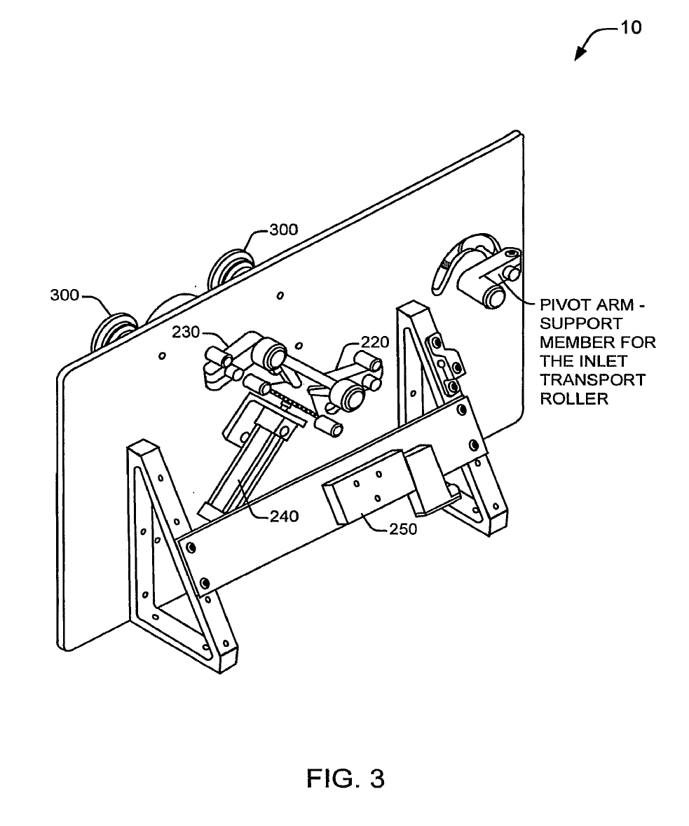

The hub assemblies 140, 150 are each mounted on corresponding idler assemblies 200, 210 (FIG. 2) and secured in place with respective spring levers 160, 170 (FIG. 1). Referring to FIG. 3, the idler assemblies 200, 210 rotate under the control of respective pivot members 220, 230 coupled to a pneumatic piston assembly 240 and a pneumatic flow control valve 250.

The hub assemblies 140, 150 upon which the adhesive members 120, 130 are mounted are identified to ensure that proper orientation is maintained. Adhesive orientation relative to the cleaning member 100,110 rotation is important to prevent the rolled adhesive from unwinding onto the cleaning member and/or film. One hub assembly 150 rotates in a clock-wise direction, while the other hub assembly 140 rotates in a counter clock-wise direction. The hub assemblies 140, 150 are rotated differently so that proper adhesive orientation is maintained in the film cleaning system 10.

Hub assemblies 140, 150 are removed from the film cleaning system by pressing the spring levers 160, 170 to release them from idler assemblies 200, 210. The tapered screws 180, 190 are loosened to release the adhesive members 120, 130 from their respective hub assemblies 140, 150. Identifying marks (not shown) on each hub assembly 140, 150 depict the direction in which the rolled adhesive material is to peel. Once a replacement adhesive member has been secured to the hub assembly, the hub assembly is pushed back onto the idler assembly and secured in place with the spring lever.

Film is provided to the cleaning system 10 via film transport roller 260 and is moved through the cleaning system using rollers 300. As the film begins its transport through the cleaning system it is brought into contact with the cleaning members 100, 110. The cleaning members 100, 110 remove debris from the film.

The cleaning members are preferably made of a adhesive material. A suitable example includes a cleaning member made of a polyurethane based material bonded to an aluminum core. The core is machined to fit onto the idler assembly. Intimate mechanical contact between the film and polyurethane based material is required for the cleaning member to be effective. The adhesive properties of the polyurethane removes the debris from the film. Suitable cleaning members are commercially available from C. C. Steven & Associates Inc., Ventura, Calif.

As the film begins its transport through the film cleaning system, the adhesive members 120, 130 are engaged with the surface of associated cleaning members 100, 110 after the film has been in contact with its surface. The adhesive members 120, 130 remove debris from the cleaning members 100, 110. When the film transport has halted the adhesive members 120, 130 are disengaged from the cleaning members 100, 110.

In this manner, the adhesive members 120, 130 prevent the cleaning members 100, 110 from being loaded with debris from the film. The adhesive members 120, 130 provide a self-cleaning attribute as well as improve the quality and cleanliness of the film. A suitable material for the adhesive member may be a roll of tape.

The dirtied adhesive material is easily peeled off and/or cut away from the adhesive members 120, 130 after the film transport has halted. Contact force between the adhesive members 120, 130 and the respective cleaning members 100, 110 may be adjusted with air pressure to optimized performance.

Although an exemplary system for cleaning color film which incorporates the teachings of the present invention has been shown and described in detail herein, those skilled in the art can readily devise many other varied embodiments that still incorporate these teachings.

1. A method for cleaning film, comprising:
transferring debris from a segment of film onto at least one cleaning member; and
transferring the debris from the at least one cleaning member onto one or more adhesive members.

2. The method of claim 1 wherein the at least on cleaning member is adhesive.

3. The method of claim 2 wherein the one or more cleaning member is made of polyurethane.

4. The method of claim 1 wherein the adhesive member is made of tape.

5. The method of claim 1 wherein debris is transferred from the segment of film to the at least one cleaning member when the cleaning member contacts the segment of film.

6. The method of claim 1 wherein the debris is transferred from the cleaning member to the one or more adhesive members when the one or more adhesive member contacts the at least one cleaning member.

7. A film cleaning system, comprising:
at least one cleaning member for removing debris from a segment of film;
an adhesive member corresponding to each of the at least one cleaning member, wherein debris is transferred from the at least one cleaning member onto the adhesive member when the adhesive member engages the at least one cleaning member.

8. The film cleaning system of claim 7 wherein the at least on cleaning member is adhesive.

9. The film cleaning system of claim 8 wherein the one or more cleaning member is made of polyurethane.

10. The film cleaning system of claim 7 wherein the adhesive member is made of tape.

11. The film cleaning system of claim 7 wherein debris is removed from the segment of film when the cleaning member contacts the segment of film.
